(19) United States
(12) Patent Application Publication
(10) Pub. No.: US 2020/0287868 A1
(43) Pub. Date: Sep. 10, 2020

(54) SYSTEMS AND METHODS FOR IN-BAND REMOTE MANAGEMENT

(71) Applicant: CradlePoint, Inc., Boise, ID (US)

(72) Inventors: GREGORY T. ANDERSEN, Boise, ID (US); J. SEAN FRESK, Caldwell, ID (US); SCOTT BONAR, Boise, ID (US)

(21) Appl. No.: 16/293,362

(22) Filed: Mar. 5, 2019

(51) Int. Cl. H04L 29/06; H04L 29/12; H04L 29/08

(52) U.S. Cl. CPC H04L 63/029; H04L 61/2567; H04L 61/2564; H04L 67/10; H04L 63/0281; H04L 61/6013; H04L 67/141

(57) ABSTRACT

Systems and methods for in-band remote management of a network asset are disclosed. Embodiments include a router, configured to provide Network Address Translation (NAT) to a private network. Communications originating outside the private network are controlled by the router. At least one network server asset is in communication with the private network and configured to run a Secure Socket Shell (SSH) protocol. The network server asset and the router initiate an SSH tunnel with remote port mapping to enable communication with another network asset.

### FIELD OF THE DISCLOSURE

This disclosure relates generally to remote network access. More particularly, systems and methods are disclosed for allowing a user to connect to a software-as-a-service (SaaS) management console and gain secure network access to private network assets.

### BACKGROUND

Typically, virtual private network (VPN) technology is used to perform remote device management of network assets on a remote private network. For example, a user may configure a node, external to the target private network, with network access, and use that external node to access the target private network nodes. Authentication is typically done with VPN authentication, or Access Control Lists, to specify which network assets in the private network can communicate with other network assets. These approaches can be, among other things, inconvenient, require prior planning, and be time consuming.

Likewise, at times members of a cloud-based network may need to access needed assets from outside the network's firewall. Circumventing the firewall may be problematic, or may expose the network to viruses, malevolent software, or the like.

There are also times when it is desirable to allow limited outside access to certain internal network assets. For example, limited outside access may be granted if a corporate network is maintained by an outside, third-party SaaS that needs access to the list of corporate employees by using lightweight directory access protocol (LDAP) to contact the corporate network's Active Directory server. In a traditional local area network (LAN), or the like, one solution to allow limited outside access is to put the Active Directory servers in a separate network location, with special fixed IP addresses, and potentially having their own firewall. However, in a cloud-based network, the solution is not as straightforward. These, and other, drawbacks of current systems and methods also exist.

### SUMMARY

Accordingly, the disclosed systems and methods address the above, and other, issues by providing ways for a user to connect to a SaaS management console and gain secure network access to private network assets. Disclosed embodiments include a system for in-band remote management of a network asset, the system including a router, configured to provide Network Address Translation (NAT), a private network, wherein communications originating outside the private network are controlled by the router, and at least one network server asset in communication with the private network and configured to run a Secure Socket Shell (SSH) protocol, and wherein the at least one network server asset and the router initiate an SSH tunnel with remote port mapping to another network asset.

Further disclosed embodiments include the communications originating outside the private network originate from an external actor. Still further disclosed embodiments include a NetCloud Management (NCM) interface configured to communicate with the router.

Also disclosed is a method for in-band remote management of a network asset, the method including initiating a stream session between a router communicating on a private network, and an NCM interface, initiating a web session with the NCM interface, creating with the NCM interface an isolated secure private session with the router by utilizing a stream session, receiving a target Uniform Resource Identifier (URI) at the NCM interface and initiating an isolated secure private session with the router, initiating a Secure Socket Shell (SSH) tunnel within the isolates secure private session, receiving translated requests through the SSH tunnel and communicating the translated requests to a server device on the private network, and transmitting responses to the translated requests through the SSH tunnel.

Also disclosed is a method for in-band remote management of a network asset, the method including initiating a stream session between a router communicating on a private network, and an NCM interface, initiating a web session with the NCM interface, initiating a Socket Secure (SOCKS) proxy session between the NCM interface and the router, initiating a SOCKS tunnel within the proxy session, receiving SOCKS requests through the SOCKS tunnel and communicating the SOCKS requests to a network asset on the private network, and transmitting responses to the SOCKS requests through the SSH tunnel. Other embodiments and methods are also possible.

### BRIEF DESCRIPTION OF THE DRAWINGS

FIG. 1 is an exemplary environment in which the presently disclosed systems and methods may be implemented.

FIG. 2 is a block diagram illustrating exemplary physical and logical components of router 26, according to embodiments of the present disclosure.

FIG. 3 is a block diagram illustrating exemplary physical and logical components of router 26, according to embodiments of the present disclosure.

FIG. 4 is a schematic illustration of embodiments of the disclosure showing some possible connections.

FIG. 5 is a schematic illustration of an environment for allowing a user to connect to a SaaS management console and gain secure network access to private network assets in accordance with disclosed embodiments.

FIG. 6 is a schematic illustration of the environment 500 of FIG. 5 illustrating an example of secure network access to private network assets in accordance with disclosed embodiments.

FIG. 7 is a schematic illustration of another environment 700 illustrating an example of secure network access to private network assets in accordance with disclosed embodiments.

FIG. 8 shows exemplary interface windows that may be implemented in conjunctions with an enterprise cloud manger (NCM) in accordance with disclosed embodiments.

FIG. 9 is an exemplary schematic diagram for secure network access to private network assets in accordance with disclosed embodiments.

FIG. 10 is an exemplary sequence diagram for secure network access to private network assets for the environment 500 of FIGS. 5-6 in accordance with disclosed embodiments.

FIG. 11 is an exemplary sequence diagram for secure network access to private network assets for the environment 700 of FIG. 7 in accordance with disclosed embodiments.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION

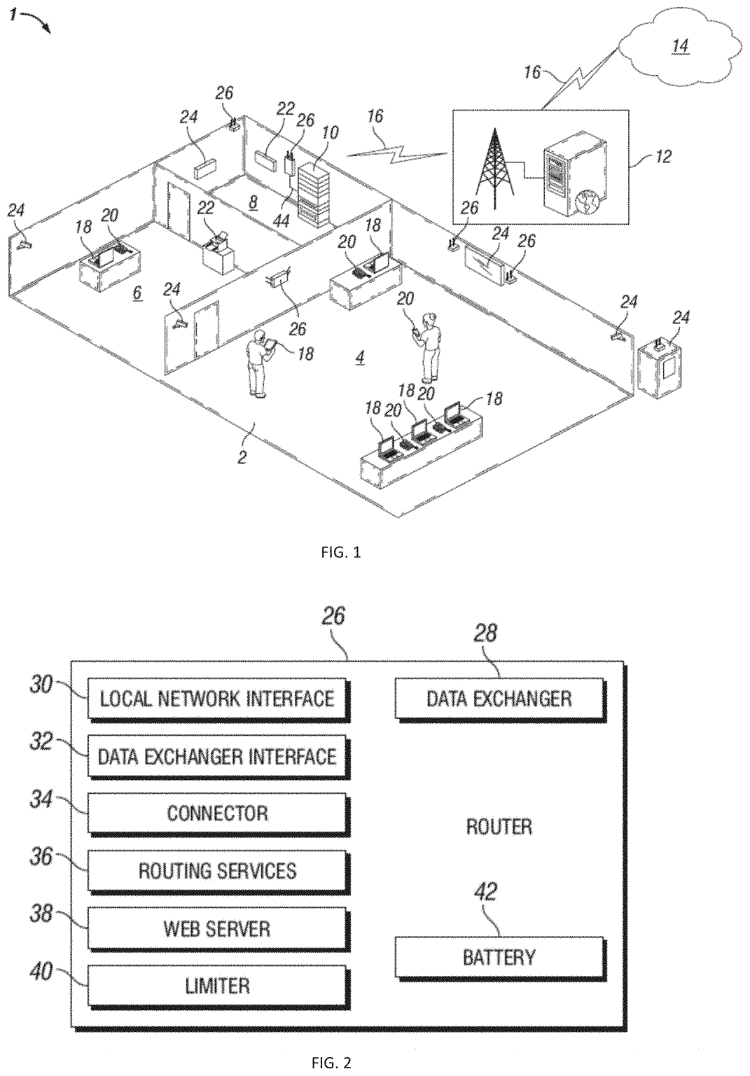

FIG. 1 is an exemplary environment in which the presently disclosed systems and methods may be implemented. As shown, environment 1 may comprise a retail establishment, a corporate office, or the like (collectively, workplace 2) which may further comprise a front area 4, a back area 6, and an equipment room 8. Of course, depending upon the type of workplace 2, more, less, or other areas may also be present. Environment 1 may further comprise one or more servers 10. Among other things, servers 10 may comprise part of a LAN in use in the customer area 4 and back office 6 and may also communicate with a wide area network (WAN), an Internet service provider (ISP) 12, and ultimately with the Internet 14. Communication between the servers 10 and the various networks may be accomplished over links 16 which represents generally any combination of a cable, wireless, or remote connection via a telecommunication link, an infrared link, a radio frequency link, or any other connector or system that provides electronic communication between servers 10 and the various networks.

As also indicated in FIG. 1, environment 1 may also comprise any number of computing devices and other peripherals and related systems (collectively, and individually “client devices” or “network assets”). For example, front area 4 and back area 6 may comprise computing devices 18 (e.g., personal computers (PCs), laptops, point-of-sale terminals, associate terminals, manager computers, employee tablet devices, smartphones, etc.), communication devices 20 (e.g., voice-over-Internet-protocol (“VoIP”) telephones, cellular phones, smartphones, etc.), and peripheral devices 22 (e.g., printers, fax machines, hard drives, storage drives, etc.).

As also indicated, environment 1 may also include other systems 24 (e.g., HVAC control systems, security systems, digital signage systems, kiosks, etc.) that communicate over one or more networks in environment 1. Other types of systems may also be included in environment 1. One or more routers 26 may also be included in environment 1. Router 26, discussed in more detail below, represents generally a device capable of routing network communications between network assets (e.g., computing devices 18, communication devices 20, peripheral devices 22, and other systems 24) and Internet 14 via a data exchanger 28.

Data exchanger 28 represents generally any combination of hardware and/or programming that can be utilized by router 10 to connect to a remote network such as the Internet. In the example of FIG. 1, the data exchanger 28 and routers 26 are incorporated within the same device and can be connected, for example, by using internal connections. In an embodiment, the data exchanger 28 may take the form of a separate device card that can be inserted into a slot provided in router 26, or otherwise connected to the router 26 through an I/O port. Alternatively, the data exchanger 28 may be fully integrated into router 26.

FIG. 2 is a block diagram illustrating exemplary physical and logical components of router 26, according to an embodiment of the present disclosure. As described above, router 26 represents generally any combination of hardware and/or programming capable functioning as a router for directing network communications between client devices on the local network, or between client devices and the Internet via a data exchanger such as an Internet enabled cellular telephone, cellular modem, DSL modem, or cable modem.

In the example of FIG. 2, router 26 includes local network interface 30 and data exchanger interface 32. Local network interface 30 represents generally any combination of hardware and/or program instructions capable of supplying a communication interface between router 26 and computing devices 18, communication devices 20, and peripheral devices 22 as shown in FIG. 1.

Data exchanger interface 32 represents any combination of hardware and/or programming enabling data to be communicated between router 26 and a data exchanger 28. For example, interfaces 30 and 32 may include a transceiver operable to exchange network communications utilizing a wireless protocol such as ultrawideband (UWB), Bluetooth, or 802.11. Alternatively, interfaces 30 and 32 may include physical ports or other physical connection points enabling wired communication.

In an embodiment, as illustrated in FIG. 2, router 26 can also include an embedded data exchanger 28 in addition to the data exchanger interface 32. As also shown in FIG. 1, data exchanger 28 allows router 26 to connect directly to ISP 12 via link 16, as opposed to employing a separate data exchanger device. In the case of a data exchanger 28 being embedded in router 26, router 26 can include a data exchanger interface 32 such as, for example, a slot for a device card, such as a cellular modem, or the like, which allows communication with the embedded data exchanger 28. Alternatively, the embedded data exchanger 28 can be fully integrated into the router 26, in which case the data exchanger interface 32 may be replaced with internal device connections.

In an embodiment, router 26 can also include router services 36 and web server 38. Routing services 36 represents generally any combination of hardware and/or programming for routing network communication received through network interface 30 to be transmitted by data exchanger 28 to Internet 14. Routing services 36 can also be responsible for routing inbound network communications received from Internet 14 and directed via network interface 30 to a specified computing device 18, communication device 20, or peripheral device 22. Outbound and inbound network communications, for example can be IP (Internet protocol) packets directed to a target on Internet 14 or to a particular networked device 18, 20, 22 on a LAN.

Web server 38 represents generally any combination of hardware and/or programming capable of serving interfaces such as web pages to networked devices 18, 20, and 22. Such web pages may include web pages that when displayed by a network device allows a user to provide or otherwise select settings related to the operation of router 26.

Router 26 can optionally include a connector 34. Connector 34 represents generally any combination of hardware and/or programming for sending a signal to data exchanger 28 to establish a data connection with service providers 12 so that access can be made to Internet 14. For example, where a data exchanger 28 is a cellular telephone, connector 34 may send a signal causing the cellular telephone to establish a data link with service provider 12. In an embodiment, the router 26 does not include a connector 34. In an embodiment, the hardware and/or programming for establishing a data connection with a service provider 12 is included in, for example, a cellular modem that is employed as the data exchanger 28, which may be incorporated into router 26, as described above.

The router 26 can optionally include a limiter 40. Limiter 40 represents generally any combination of hardware and/or programming capable of distinguishing among the users of devices such as networked assets 18, 20, and 22, and applying different Internet access rules for different users. For example, certain Internet access rules may apply to the owner of router 26. In this context, the term owner refers to an individual or entity that is a subscriber with respect to a service provider such as service provider 12 shown in FIG. 1. The owner typically has physical possession or otherwise has control of router 26. Other Internet access rules can apply to users authorized by the owner. Yet other Internet access rules apply to anonymous users. Where network interface 30 provides for a wireless connection with networked assets 18, 20, and 22, a user of a particular device might not be known by the owner. As such, Internet access rules for such users may be quite limiting. The limiter 40 and operation thereof are discussed in greater detail in U.S. Pat. No. 9,232,461, filed Feb. 12, 2007, in the name of Pat Sewall, et al., and titled “Hotspot Communication Limiter,” the disclosure of which is hereby incorporated by reference in its entirety.

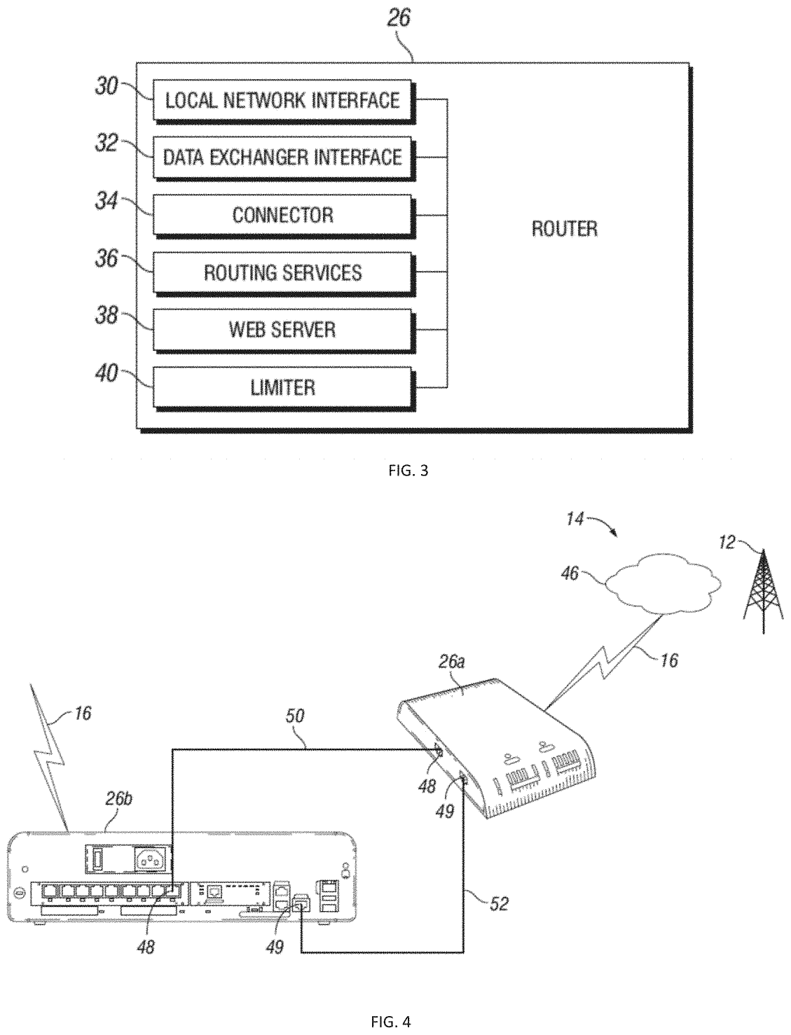

In some embodiments, one or more of the features shown in FIGS. 2 and 3 may not be included. For example, router 26 can include a local network interface 30, a data exchanger interface 32, a connector 34, routing services 36, a web server 38 and a data exchanger 28, but not a limiter 40. In an embodiment, router 26 may optionally include a battery 42 or other form of self-contained source of power to provide electrical power for the router 26 to function. As shown in FIGS. 2 and 3, and described above, router 26 may not have an embedded or enclosed data exchanger 28, but instead may employ an external data exchanger 28 that is connected to the router 26 through a device link 44. Device link 44 may be any suitable link, such as a cable, or a direct physical connection between the data exchanger 28 and the router 26, or a form of wireless communication.

FIG. 4 is a schematic illustration of embodiments of the disclosure showing some possible connections. As shown, a wireless router 26a may communicate over a cellular link 16 to the Internet 14 over a service provided by an ISP 12. As also illustrated, a SaaS management console, such as NetCloud manager (“NCM”) 46, may reside on the Internet 14. NCM 46 may comprise an Application Program Interface (“API”) and other network management tools that may enable remote management of an environment 1 and the networks contained therein. The API may comprise a REST API 54. NCM 46 may enable the remote monitoring of status of network assets (e.g., 18, 20, 22, or 24) and may enable to generation of network analytics, diagnostics, or the like.

As also illustrated, wireless router 26a may also have a number of connection ports 48, 49. For example, connection ports may comprise RF connection ports (e.g., WiFi, Zigbee, Bluetooth, cellular, or the like (not shown), Ethernet connection ports 48, serial connection ports 49, or the like. As illustrated, wireless router 26a may be connected to a primary router 26b using an Ethernet connection 50 via Ethernet connection ports 48, or a serial connection 52 may be established via corresponding serial connection ports 49. As illustrated primary router 26b may reside on a network (e.g., LAN, WAN, or the like) in environment 1 and may communicate with network assets via a wired or wireless link 16.

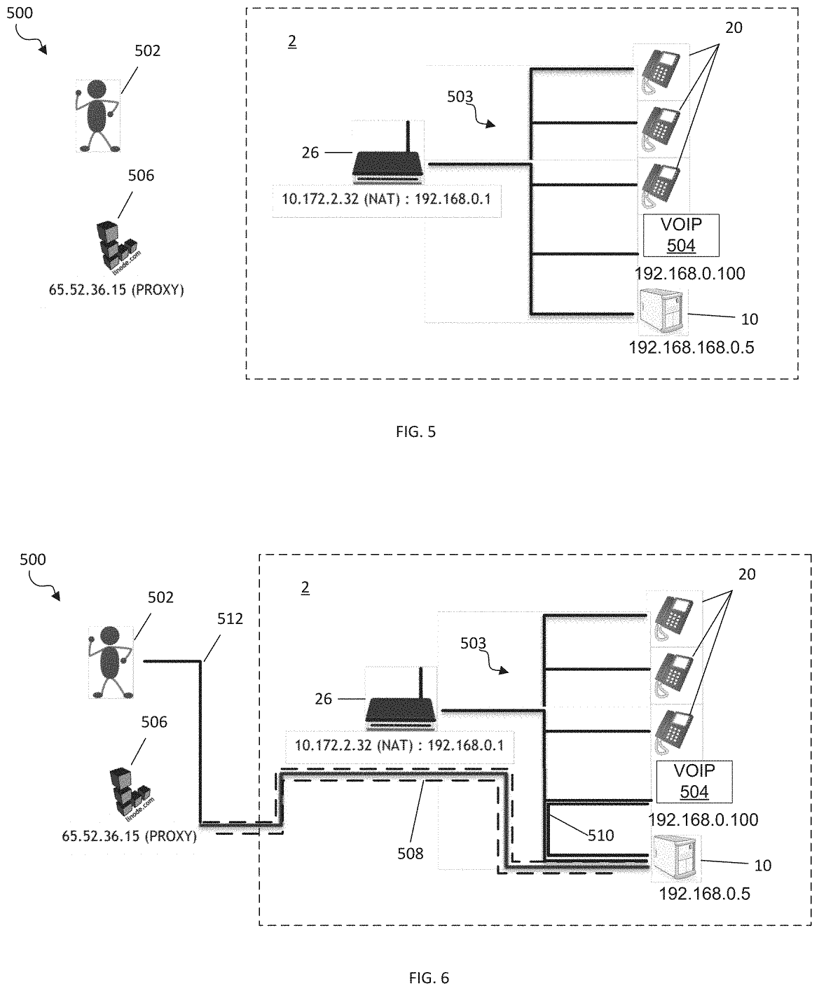

FIG. 5 is a schematic illustration of an environment 500 for allowing a user 502 to connect to a SaaS management console (e.g., NCM 46) and gain secure network access to private network 503 assets (e.g., 10, 18, 20, 22, 24, 504) in accordance with disclosed embodiments. For example, user 502 may want to access the web management interface for a Voice-Over-Internet-Protocol (VOIP) system 504 at a remote office 2 that is behind a Network Address Translation (NAT) provided by router 26 that has an internal private address of 192.168.0.100 running an HTTP webserver (e.g., webserver 38) on port 80. As shown in FIG. 5, a separate entity such as server 10 on the internal network 503 runs Secure Socket Shell (SSH) with an IP address of 192.168.168.0.5. As also shown, there is a publicly available cloud server (PROXY) 506 running an open SSH protocol, such as SSHD, with an IP address of 65.52.36.15.

FIG. 6 is a schematic illustration of the environment 500 of FIG. 5 illustrating an example of secure network access to private network 503 assets (e.g., 10, 18, 20, 22, 24, 504) in accordance with disclosed embodiments. As shown, and discussed above, cloud PROXY server 506 is running an open SSH protocol, such as SSHD. PROXY server 506 is also configured to enable GatewayPorts in a configuration setting (such as /etc/ssh/ssh_config) to allow the remote SSH to bind to public IP addresses. A network 503 asset, such as server 10, is configured to run SSH. Server 10 also provides machine credentials (e.g., certificates) for the PROXY server 506. PROXY server 506 and network 503 asset server 10 communicate to initiate an SSH tunnel 508 with a remote port mapping (schematically indicated at 510) to another network 503 asset, in this case, VOIP system 504. An example of the mapping of FIG. 6 is: ssh -p<sshd running port>[-C(compression)]-i <proxy-server-id-file>-R0.0.0.0:<bind-port>:<target-server-ip>:<target-server-port><proxy-server-user>@<proxy-server-ip> and ssh -p 22 -C -i proxy_cert.key -R 0.0.0.0:4455:192.168.0.100:80 proxyuser@65.52.36.15.

As also indicated schematically in FIG. 6, user 502 makes a request 512 to PROXY:PORT which will connect to IP address 192.168.0.100:80, for example by executing a command such as: curl http://65.52.36.15:4455. The request 512 goes to PROXY server 506 at port 4455 (not shown), and port 4455 is bound to SSH tunnel 508 to SSH protocol. Traffic flows are then encrypted through SSH tunnel 508 to IP address 192.168.0.5 which is the IP address for network 503 server 10. Traffic is then forwarded by server 10 at IP address 192.168.0.5 to VOIP system 504 at IP address 192.168.0.100. For this embodiment, communications return in reverse over the same path through the SSH tunnel 508.

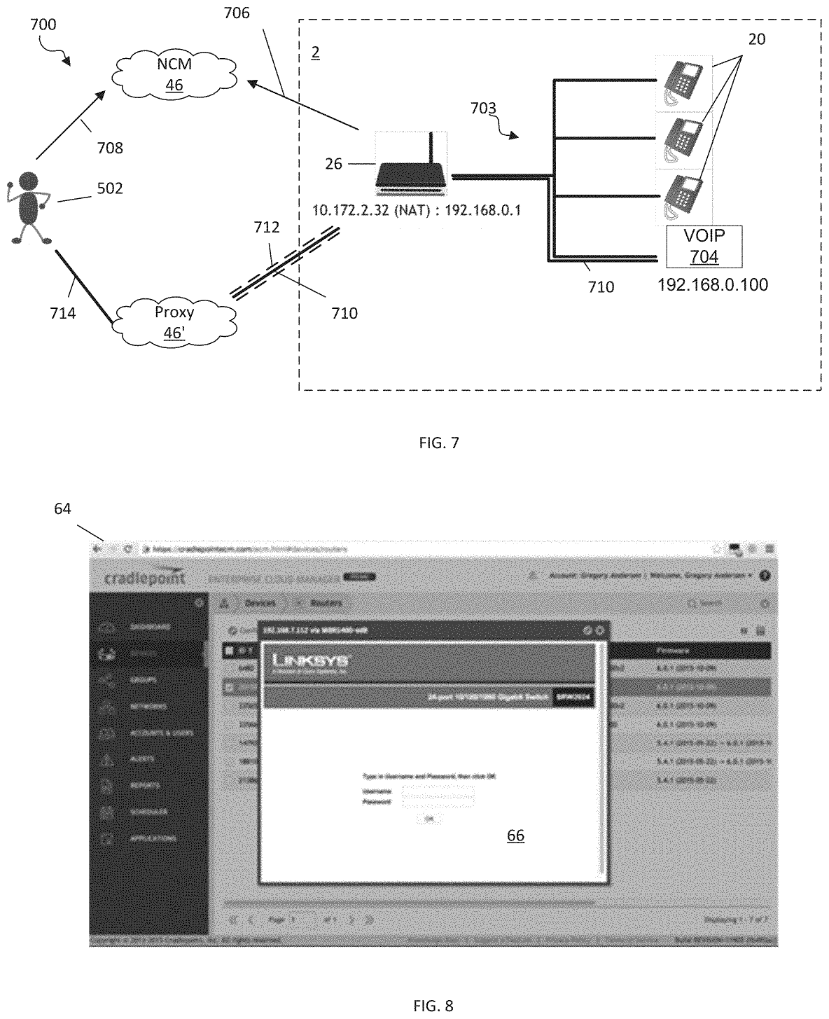

FIG. 7 is a schematic illustration of another environment 700 illustrating an example of secure network access to private network 703 assets (e.g., 10, 704, 18, 20, 22, 24) in accordance with disclosed embodiments. As shown, in this embodiment user 502 may have remote access to remote workplace 2 via an NCM 46. Likewise, router 26 may communicate with NCM 46 over stream connection 706. A user 502 logs into the NCM 46 and requests at 708 a connection to the VOIP system 704 located at IP address 192.168.0.100. NCM 46 requests over the stream connection 706 that router 26 connect, as indicated by connection 710, to a proxy 46′ on port 4455 via a SSH tunnel 712. Router 26 also connects to the requested asset, in this example VOIP system 704, over connection 710 via internal network 703. As indicated, router 26 initiates an outbound SSH connection 714 via proxy 46′ to the network 703 asset, VOIP system 704.

FIG. 8 shows exemplary interface windows that may be implemented in conjunctions with the NCM 46 in accordance with disclosed embodiments. For example, NCM 46 may comprise an interface window 64 with various, software interfaces that enable a user to establish the connections with the remote network 703 asset (e.g., router 26) as discussed herein. As also shown schematically, an inline frame 66, or new tab (not shown) on interface 64, opens when NCM 46 translates the original URI to the proxy URL (e.g., http://proxy.NCM.com:4455) and opens the inline frame 66 to enable the user 502 to perform configuration, troubleshooting, repair, diagnostic, or other operations as desired. Additionally, since the URL proxy.NCM.com receives the NCM 46 session cookie, it can authenticate the user 502 through an NGINX proxy (instead of direct socket connection). NGINX proxy may also modify HTTP headers (to allow framing if requested).

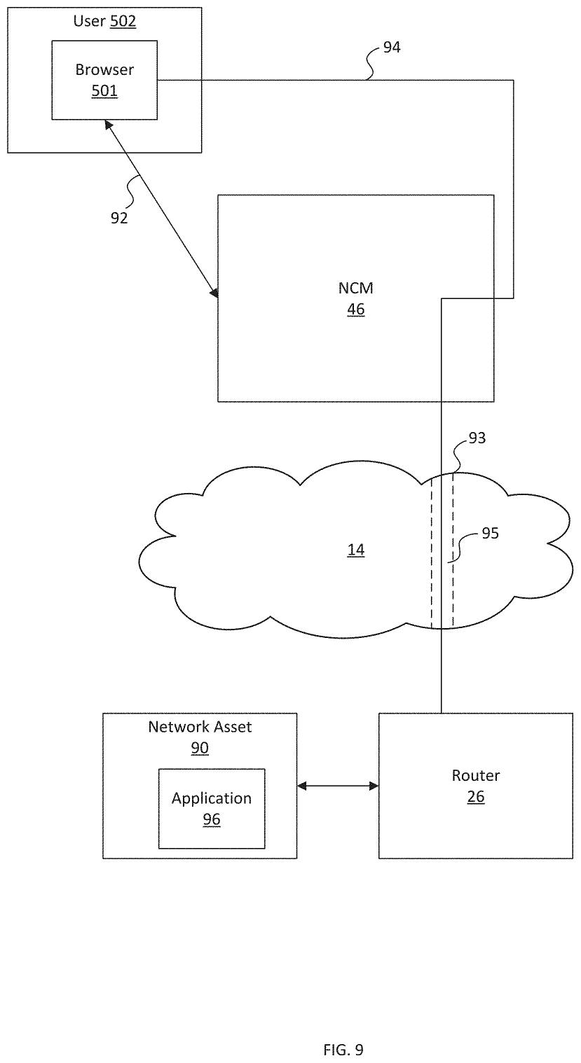

FIG. 9 is an exemplary schematic flow diagram for secure network access to private network assets 90 in accordance with disclosed embodiments. As indicated at 92, a user 502 using a browser 501 initially logs into and authenticates with NCM 46 and the browser 501 receives a JavaScript web token (JWT) in exchange for that authentication. As indicated at 94, the user 502 uses browser 501 to initiate a tunnel 95 to a router 26 (or application 96 behind that router 26). The NCM 46 configures the tunnel 95 and creates an entry in a route map from a publicly accessible endpoint 93 in the cloud 14. The user's 502 browser 501 is redirected to that shared public endpoint 93 which includes the original JWT authentication. When the public endpoint 93 receives the JWT it looks up in the routing table the session associated with the tunnel 95 ID, ensures the user 502 is authenticated for that tunnel 95 and routes the session to the appropriate backend (e.g., router 26, network asset 90, application 96, or the like). As disclosed herein, the user 502 may then conduct a session with the network asset 90, application 96, or router 26 in any IP protocol (e.g., SSH, HTTP, serial-over-IP, RDP, or the like). When the user 502 shuts down the tunnel 95 (or it is torn down administratively) the router 26 is removed and the tunnel 95 is no longer publicly accessible.

As will be apparent to those of ordinary skill in the art having the benefit of this disclosure, the herein disclosed systems and methods enable authentication from end-to-end from a user 502 interacting with NCM 46 to end network asset 90. The JWT stored temporarily in browser 501, communicates that token on each request, each entity in the stack validates the user 502 should have access to end network asset 90. The JWT also ensures the user 502 that initiated the tunnel 95 connection is the only one able to utilize the tunnel 95. Network assets 90 that comprise devices that normally wouldn't have a secure channel, such as a webcam, without security would inherently be secured using the disclosed systems and methods. One time use keys (such as RSA keys) are generated for each session and exchanging with the user 502 and NCM 46 to provide that security.

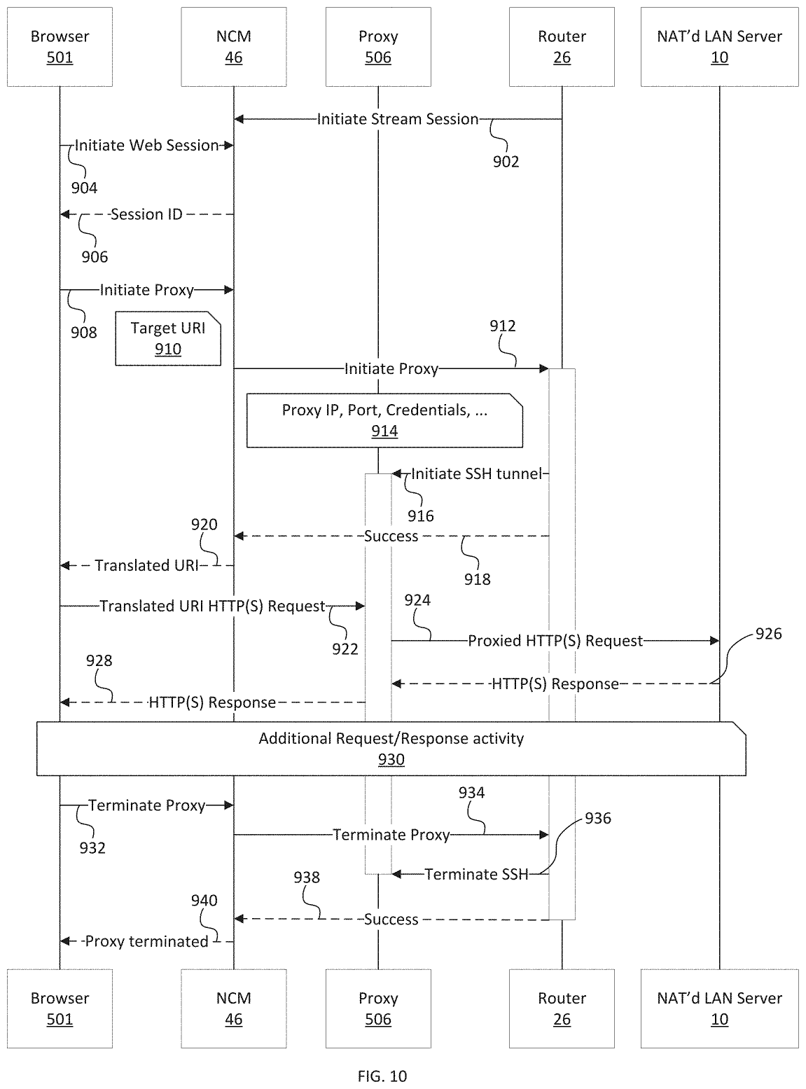

FIG. 10 is an exemplary sequence diagram for secure network access to private network assets for the environment 500 of FIGS. 5-6 in accordance with disclosed embodiments. As shown, communications from a user's 502 browser 501 interface, and other environment 500 components occur as follows. At 902 a stream session between router 26 and NCM 46 occurs. At 904 user 502 at a browser 501 initiates a web session with NCM 46 and, at 906, the session ID is communicated to the browser 501. At 908 a proxy session is initiated and the target URI 910 is communicated to NCM 46 which, at 912, initiates the proxy session with router 26 and communicates the Proxy IP address, port, credentials, etc., 914. At 916 router 26 initiates the SSH tunnel and communicates successful initiation at 918 to NCM 46. NCM 46 then communicates at 920 the translated URI. At 922 browser 501 communicates the translated URI http(s) request to proxy 506 which communicates at 924 the proxied http(s) request to the NAT′d LAN server 10. At 926 NAT'd LAN server 10 communicates an http(s) response to proxy 506 which communicates the response to the browser 501 at 928. As indicated at 930 additional request/response activity may continue as desired for the SSH session. When user 502 terminates the session, a terminate proxy message is communicates at 932 from the browser 501 to NCM 46 and from NCM 46 to router 26 as indicated at 934. At 936 the router communicates a terminate SSH message the success of which is communicated from the router 26 to the NCM 46 as indicated at 938. At 940 the NCM 46 communicates the proxy is terminated to the browser 510.

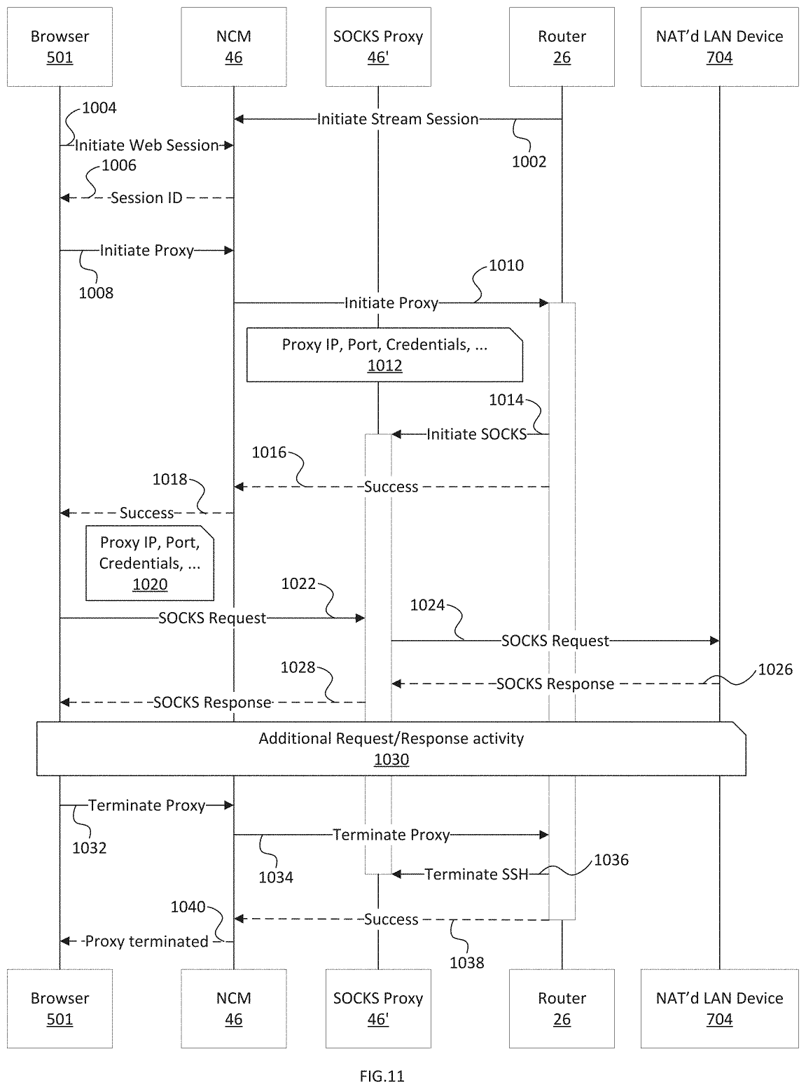

FIG. 11 is an exemplary sequence diagram for secure network access to private network assets for the environment 700 of FIG. 7 in accordance with disclosed embodiments. As shown, communications from a user's 502 browser 501 interface, and other environment 700 components occur as follows. At 1002 a stream session between router 26 and NCM 46 occurs. At 1004 user 502 at a browser 501 initiates a web session with NCM 46 and, at 1006, the session ID is communicated to the browser 501. At 1008 a proxy session is initiated and communicated to NCM 46 which, at 1010, initiates the proxy session with router 26 and communicates the Proxy IP address, port, credentials, etc., 1012. At 1014 router 26 initiates a Socket Secure (SOCKS) session with SOCKS proxy 46′ and communicates successful initiation at 1016 to NCM 46. NCM 46 then communicates at 1018 successful initiation and communicates the proxy IP address, port, credentials, etc., 1020. At 1022 browser 501 communicates a SOCKS request to SOCKS proxy 46′ which communicates at 1024 the SOCKS request to the NAT′d LAN device 704. At 1026 NAT′d LAN device 704 communicates a SOCKS response to SOCKS proxy 46′ which communicates the response to the browser 501 at 1028. As indicated at 1030 additional request/response activity may continue as desired for the SOCKS session. When user 502 terminates the session, a terminate proxy message is communicates at 1032 from the browser 501 to NCM 46 and from NCM 46 to router 26 as indicated at 1034. At 1036 the router communicates a terminate SSH message the success of which is communicated from the router 26 to the NCM 46 as indicated at 1038. At 1040 the NCM 46 communicates the proxy is terminated to the browser 510.

Although various embodiments have been shown and described, the present disclosure is not so limited and will be understood to include all such modifications and variations would be apparent to one skilled in the art.

What is claimed is:

1. A system for in-band remote management of a network asset, the system comprising:
a router, configured to provide Network Address Translation (NAT);
a private network, wherein communications originating outside the private network are controlled by the router; and
at least one network server asset in communication with the private network and configured to run a Secure Socket Shell (SSH) protocol, and wherein the at least one network server asset and the router initiate an SSH tunnel with remote port mapping to another network asset.

2. The system of claim 1 wherein the communications originating outside the private network originate from an external actor.

3. The system of claim 2 further comprising a NetCloud Management (NCM) interface configured to communicate with the router.

4. A method for in-band remote management of a network asset, the method comprising:
initiating a stream session between a router communicating on a private network, and an NetCloud Management (NCM) interface;
initiating a web session with the NCM interface;
creating with the NCM interface an isolated secure private session with the router by utilizing a stream session;
receiving a target Uniform Resource Identifier (URI) at the NCM interface and initiating an isolated secure private session with the router;
initiating a Secure Socket Shell (SSH) tunnel within the isolates secure private session;
receiving translated requests through the SSH tunnel and communicating the translated requests to a server device on the private network; and
transmitting responses to the translated requests through the SSH tunnel.

5. A method for in-band remote management of a network asset, the method comprising:
initiating a stream session between a router communicating on a private network, and an NetCloud Management (NCM) interface;
initiating a web session with the NCM interface;
initiating a Socket Secure (SOCKS) proxy session between the NCM interface and the router;
initiating a SOCKS tunnel within the proxy session;
receiving SOCKS requests through the SOCKS tunnel and communicating the SOCKS requests to a network asset on the private network; and
transmitting responses to the SOCKS requests through the SSH tunnel.
